(19) United States
(12) Patent Application Publication
(10) Pub. No.: US 2024/0103924 A1
(43) Pub. Date: Mar. 28, 2024

(54) DYNAMIC USER PROFILING BASED ON USAGE PATTERNS

(71) Applicant: INTERNATIONAL BUSINESS MACHINES CORPORATION, ARMONK, NY (US)

(72) Inventors: Gerard Lawrence Pinto, Livermore, CA (US); Lalit Somavarapha, Fremont, CA (US); Matthias Seul, Folsom, CA (US)

(21) Appl. No.: 17/935,220

(22) Filed: Sep. 26, 2022

(51) Int. Cl. G06F 9/50

(52) U.S. Cl. CPC G06F 9/505; G06F 9/5072; G06F 2209/501; G06F 2209/5022; G06F 2209/505

(57) ABSTRACT

A method, computer program, and computer system are provided for resource allocation in a cloud computing environment. A request for resource allocation is received from a user in a cloud computing environment. A profile is determined for the user based on one or more metrics. A workload allocation is assigned to the user based on the determined profile matching one or more clusters of other users. A usage value of the assigned workload allocation to the user may be monitored. The user is immediately upgraded to a higher workload allocation based on the usage value exceeding a threshold value.

### FIELD

This disclosure relates generally to field of cloud computing, and more particularly to computer resource allocation.

### BACKGROUND

In a cloud computing environment, resource scaling refers to the amount and type of resources that need to be allocated to one or more users.

### SUMMARY

Embodiments relate to a method, system, and computer readable medium for resource allocation in a computing environment. According to one aspect, a method for resource allocation in a computing environment is provided. The method may include receiving a request for resource allocation from a user in a cloud computing environment. A profile is determined for the user based on one or more metrics. A workload allocation is assigned to the user based on the determined profile matching one or more clusters of other users. A usage value of the assigned workload allocation to the user may be monitored. The user is immediately upgraded to a higher workload allocation based on the usage value exceeding a threshold value.

According to another aspect, a computer system for resource allocation in a computing environment is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving a request for resource allocation from a user in a cloud computing environment. A profile is determined for the user based on one or more metrics. A workload allocation is assigned to the user based on the determined profile matching one or more clusters of other users. A usage value of the assigned workload allocation to the user may be monitored. The user is immediately upgraded to a higher workload allocation based on the usage value exceeding a threshold value.

According to yet another aspect, a computer readable medium for resource allocation in a computing environment is provided. The computer readable medium may include one or more computer-readable storage devices and program instructions stored on at least one of the one or more tangible storage devices, the program instructions executable by a processor. The program instructions are executable by a processor for performing a method that may accordingly include receiving a request for resource allocation from a user in a cloud computing environment. A profile is determined for the user based on one or more metrics. A workload allocation is assigned to the user based on the determined profile matching one or more clusters of other users. A usage value of the assigned workload allocation to the user may be monitored. The user is immediately upgraded to a higher workload allocation based on the usage value exceeding a threshold value.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment according to at least one embodiment;

FIG. 2 illustrates a networked computer environment according to at least one embodiment

FIG. 3 is a block diagram of a system for resource allocation in a computing environment, according to at least one embodiment;

FIG. 4 is an operational flowchart illustrating the steps carried out by a program that allocates resources in a computing environment based on user profile, according to at least one embodiment; and

FIG. 5 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

Embodiments relate generally to the field of cloud computing, and more particularly to computer resource allocation to users within a cloud computing environment. The following described exemplary embodiments provide a system, method, and computer program to, among other things, dynamically allocate user resources based on user profile. Therefore, some embodiments have the capacity to improve the field of computing by allowing for immediately upgrading and gradually downgrading user resource allocations without affecting the user experience.

As previously described, in a cloud computing environment, resource scaling refers to the amount and type of resources that need to be allocated to one or more users. However, resource scaling is generally a static process. For example, after an application is developed and a workload allocation is determined, a user may be provisioned such computer resources within the cloud computing environment but may only utilize these resources for a short time period, such as a few seconds per day. On the other had, a second user of the cloud computing environment may be a “power user” with the same allocation but may encounter performance issues due to reaching the resource limit frequently during the course of a day. It may be advantageous, therefore, to dynamically allocate resources based on users' needs without impacting performance. This may be achieved by immediately and progressively upgrading the allocation to users once certain thresholds are reached and gradually downgrading allocations to users over time to lower allocations that may be sufficient for such users' needs at that time.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

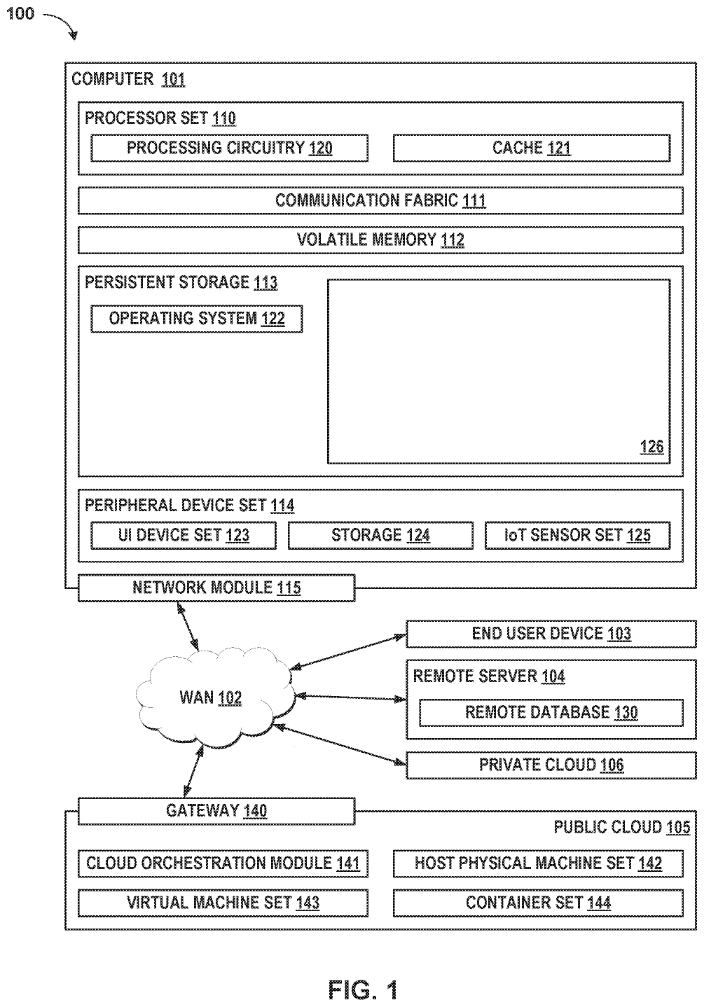

The following described exemplary embodiments provide a system, method and computer program that dynamically allocates resources to users based on a user profile with the user and automatically upgrades and gradually downgrades the user's allocation based on usage and other metrics. These metrics may be related to user experience or perceived performance, or as otherwise described herein. Referring now to FIG. 1, Computing environment 100 contains an example of an environment for the execution of at least some of the computer code involved in performance of embodiments disclosed herein, such as Resource Allocation 126. In addition to Resource Allocation 126, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Resource Allocation 126, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Resource Allocation 126 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Resource Allocation 126 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization. In the method, computer program, and computer readable medium disclosed herein, the resources of the container may be allocated to users and may be dynamically readjusted based on users' usage of such resources.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

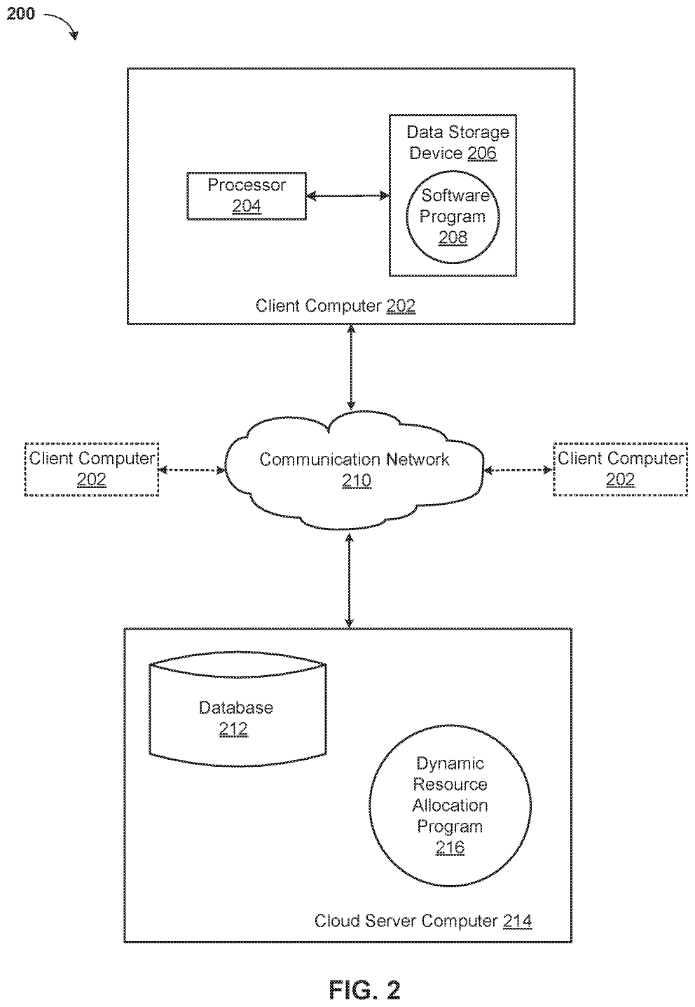

Referring now to FIG. 2, a functional block diagram of a networked computer environment illustrating a dynamic resource allocation system 200 (hereinafter “system”) for allocating computer resources in a cloud computing environment based on a user profile. It should be appreciated that FIG. 2 provides only an illustration of one implementation and does not imply any limitations with regard to the environments in which different embodiments may be implemented. Many modifications to the depicted environments may be made based on design and implementation requirements.

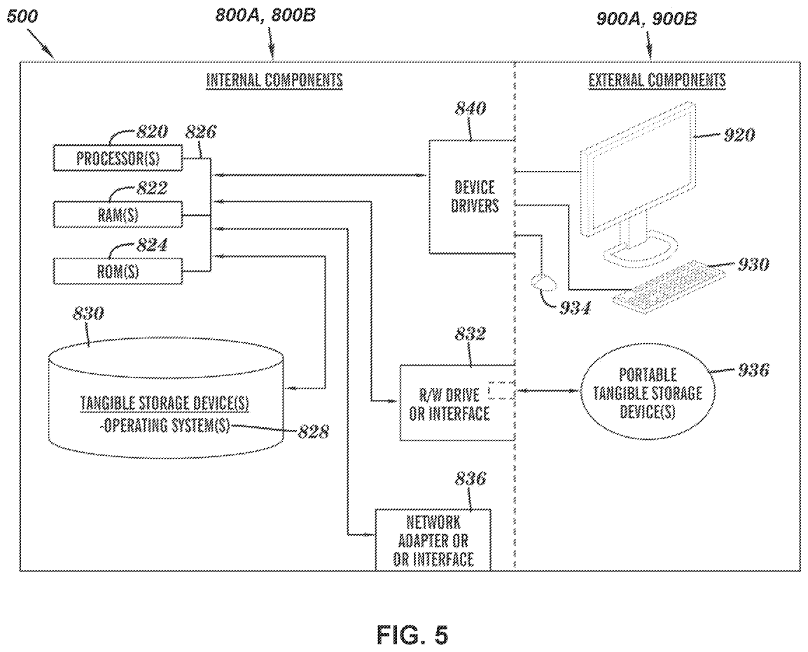

The system 200 may include a client computer 202 and a cloud server computer 214. The client computer 202 may communicate with the cloud server computer 214 via a communication network 210 (hereinafter “network”). The client computer 202 may include a processor 204 and a software program 208 that is stored on a data storage device 206 and is enabled to interface with a user and communicate with the cloud server computer 214. As will be discussed below with reference to FIG. 5, the client computer 202 may include internal components 800A and external components 900A, respectively, and the cloud server computer 214 may include internal components 800B and external components 900B, respectively. The client computer 202 may be, for example, a mobile device, a telephone, a personal digital assistant, a netbook, a laptop computer, a tablet computer, a desktop computer, or any type of computing devices capable of running a program, accessing a network, and accessing a database.

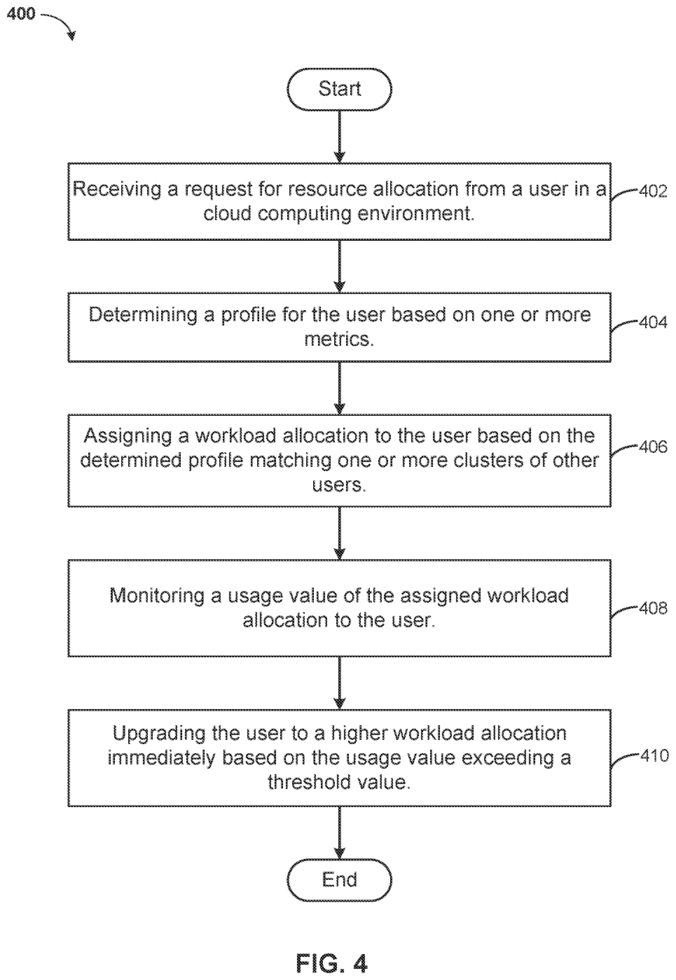

The cloud server computer 214, which may be used for resource allocation based on user profile is enabled to run a Dynamic Resource Allocation Program 216 (hereinafter “program”) that may interact with a database 212. The Dynamic Resource Allocation Program is explained in more detail below with respect to FIG. 4. In one embodiment, the client computer 202 may operate as an input device including a user interface while the program 216 may run primarily on cloud server computer 214. In an alternative embodiment, the program 216 may run primarily on one or more client computers 202 while the cloud server computer 214 may be used for processing and storage of data used by the program 216. It should be noted that the program 216 may be a standalone program or may be integrated into a larger dynamic resource allocation program.

It should be noted, however, that processing for the program 216 may, in some instances be shared amongst the client computers 202 and the cloud server computers 214 in any ratio. In another embodiment, the program 216 may operate on more than one computer, server computer, or some combination of computers and server computers, for example, a plurality of client computers 202 communicating across the network 210 with a single cloud server computer 214. In another embodiment, for example, the program 216 may operate on a plurality of cloud server computers 214 communicating across the network 210 with a plurality of client computers. Alternatively, the program may operate on a network server communicating across the network with a server and a plurality of client computers.

The network 210 may include wired connections, wireless connections, fiber optic connections, or some combination thereof. In general, the network 210 can be any combination of connections and protocols that will support communications between the client computer 202 and the cloud server computer 214. The network 210 may include various types of networks, such as, for example, a local area network (LAN), a wide area network (WAN) such as the Internet, a telecommunication network such as the Public Switched Telephone Network (PSTN), a wireless network, a public switched network, a satellite network, a cellular network (e.g., a fifth generation (5G) network, a long-term evolution (LTE) network, a third generation (3G) network, a code division multiple access (CDMA) network, etc.), a public land mobile network (PLMN), a private network, an ad hoc network, an intranet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of system 200 may perform one or more functions described as being performed by another set of devices of system 200.

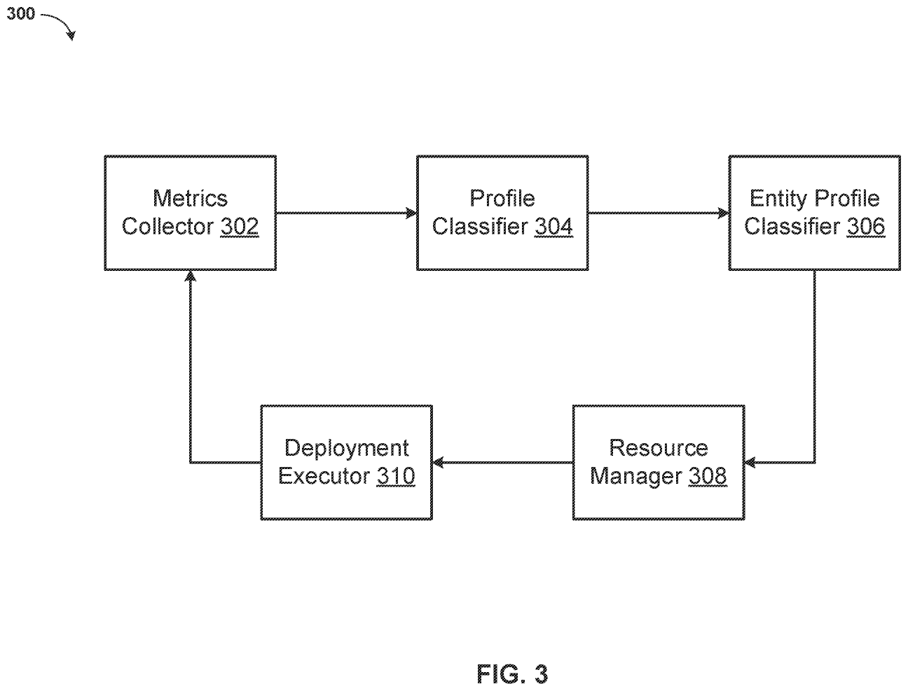

Referring now to FIG. 3, a dynamic resource allocation system 300 is depicted according to one or more embodiments. The dynamic resource allocation system 300 may include, among other things, a metrics collector 302, a profile classifier 304, an entity profile classifier 306, a resource manager 308, and a deployment executor 310.

The metrics collector 302 may gather metrics about each user of a cloud application executing in a cloud computing environment. These metrics may include, among other things, CPU usage, memory usage, past usage for a given time period, user role, time and day of the week, and types of API requests made. The metrics collector 302 may provide these metrics to the profile classifier 304.

The profile classifier 304 may determine clusters based on the collected metrics associated with each user of a plurality of users in the cloud computing environment. In effect, each cluster includes users using a similar amount of computer resources within the cloud computing environment, such as similar amounts of CPU usage, computer memory, network bandwidth, etc. The clusters may be determined using a k-nearest neighbors function based on variance between the users. The profile classifier 304 may calculate distances between users as a²+b²+c², where a, b, and c may be metrics measured for each user by the metrics collector 302. The clusters may include groupings of users such as light users, regular users, and power users. The profile classifier 304 may also progressively adjust the number of clusters based on minimizing the variance between the clusters.

The entity profile classifier 306 may assign users to the clusters determined by the profile classifier 304. Because the entity profile classifier 306 has profiled all existing users based on metrics, the entity profile classifier 306 is aware of how users interact with the application and their resource requirements. Thus, as new users utilize the application, the entity profile classifier 306 may assign new users with a given role to a cluster containing the most users with a similar role such that the new user may slot in seamlessly.

The resource manager 308 may periodically review the resources assigned to each user or cluster and re-allocate the resources accordingly. For example, in the event that a user reaches a resource utilization threshold, the user may be immediately upgraded to a higher resource allocation in order to provide a seamless user experience. Alternatively, should a user under-utilize resources, the user may be gradually downgraded to a lower allocation. This may ensure that such users are not greatly affected should they run a task with high resource utilization or log into the application after a period of prolonged inactivity. The deployment executor 310 may deploy the resources to the users based on the allocations determined by the resource manager 308. Thus, the resource manager 308 may allocate resources based upon predictive characteristics of expected usage by each user during the course of a day.

The resource manager 308 may assign resources based on metrics thresholds being reached, such that user experience is not impacted. For example, the resource manager 308 may consider processing delays, total end-to-end processing times, lag, bandwidth saturation, number of timeouts, number of “busy” responses, general I/O queue, network queue, average I/O response time etc. to determine what is considered acceptable performance. If the resource manager 308 determines these metrics are within a “great” range, the resource manager 308 may scale down provisioned resources until they land in a “good” or “acceptable” range without the resources falling into a “bad” or “inacceptable” range. Such ranges may be measured on a per metric-basis. In the case of lag, for example, lag of 2000 milliseconds may be considered “unacceptable,” 800 milliseconds may be considered “acceptable,” 400 milliseconds may be considered “good,” and any value less than 400 milliseconds may be considered “great.” The per-metric ratings can also be summarized by giving each metric an individual score (unacceptable=1, great=5), adding the scores, and deriving a total experience score. In one approach, the total score may be divided by the total number of factors. Alternatively, a weighted approach may also be used, in which certain metrics contribute more or less to the overall experience score. Thus, the resource manager 308 may be configured such that all metrics may be targeted to fall within the “acceptable” range or for the total experience score to have an overall rating of “good” even if some individual ratings may dip to “acceptable” or below. For each metric, an influencing resource may also be associated. The resource manager 308 may add more CPU resources to a machine with an “unacceptable” lag metric. The resource manager 308 may also apply broad increases or decreases in CPU, memory, I/O, and bandwidth in order to keep the experience score within the desired level.

Referring now to FIG. 4, an operational flowchart illustrating the steps of a method 400 carried out by a program that allocates resources based on user profile is depicted. The method 400 may be described with the aid of the exemplary embodiments of FIGS. 1-3.

At 402, the method 400 may include receiving a request for resource allocation from a user. The resources may include, among other things, CPU, memory, I/O, and bandwidth within a cloud computing environment. In operation, the Dynamic Resource Allocation Program 216 (FIG. 2) on the cloud server computer 214 (FIG. 2) may receive a request for resources from a user using the software program 208 (FIG. 2) on the client computer 202 (FIG. 2) over the communication network 210 (FIG. 2).

At 404, the method 400 may include determining a profile for the user based on one or more metrics. The profile for the user is determined based on calculating a nearest neighbor distance between the user and a plurality of other users in the one or more clusters. The profile for the user may also be determined based on the metrics having predefined weight values. The metrics may include, among other things, a CPU usage amount, a memory usage amount, past usage for a given time period, a user role, a time and a day of the week, and types of API requests made by the user. In operation, the metrics collector 302 (FIG. 3) may gather metrics from the user of the software program 208 (FIG. 2). The profile classifier 304 (FIG. 3) may create a set of profiles corresponding to the user and other users of the software program 208 based on the metrics gathered by the metrics collector 302.

At 406, the method 400 may include assigning a workload allocation to the user based on the determined profile matching one or more clusters of other users. A new user may also be assigned to one of the one or more clusters based on identifying a role associated with the new user matches a largest number of users within the cluster. In operation, the entity profile classifier 306 (FIG. 2) may allocate resources to the user of the software program 208 (FIG. 2) based on assigning the user to a profile created by the profile classifier 304 (FIG. 3).

At 408, the method 400 may include monitoring a usage value of the assigning workload allocation to the user. This monitoring may include whether a user is using the allocated resources or a determination that the user is idle or inactive for a predetermined amount of time. In operation, the resource manager 308 (FIG. 3) may monitor the resource usage of the user of the software program 208 (FIG. 2) to determine the resource usage of the user.

At 410, the method 400 may include immediately upgrading the user to a higher workload allocation based on the usage value exceeding a threshold value. The user may also be gradually downgraded based on determining that the user is underutilizing the allocated resources. In operation, the resource manager 308 (FIG. 3) may make a determination to immediately upgrade or gradually downgrade the user of the software program 208 (FIG. 2) based on the determined resourced usage. The deployment executor 310 (FIG. 3) will carry out the assignment of resources to the user.

It may be appreciated that FIG. 4 provides only an illustration of one implementation and does not imply any limitations with regard to how different embodiments may be implemented. Many modifications to the depicted environments may be made based on design and implementation requirements.

FIG. 5 is a block diagram 500 of internal and external components of computers depicted in FIG. 1 in accordance with an illustrative embodiment. It should be appreciated that FIG. 5 provides only an illustration of one implementation and does not imply any limitations with regard to the environments in which different embodiments may be implemented. Many modifications to the depicted environments may be made based on design and implementation requirements.

Client computer 202 (FIG. 2) and cloud server computer 214 (FIG. 2) may include respective sets of internal components 800A,B and external components 900A,B illustrated in FIG. 5. Each of the sets of internal components 800 include one or more processors 820, one or more computer-readable RAMs 822 and one or more computer-readable ROMs 824 on one or more buses 826, one or more operating systems 828, and one or more computer-readable tangible storage devices 830.

Processor 820 is implemented in hardware, firmware, or a combination of hardware and software. Processor 820 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 820 includes one or more processors capable of being programmed to perform a function. The one or more buses 826 include a component that permits communication among the internal components 800A,B.

The one or more operating systems 828, the software program 108 (FIG. 2) and the Dynamic Resource Allocation Program 216 (FIG. 2) on cloud server computer 214 (FIG. 2) are stored on one or more of the respective computer-readable tangible storage devices 830 for execution by one or more of the respective processors 820 via one or more of the respective RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory, an optical disk, a magneto-optic disk, a solid-state disk, a compact disc (CD), a digital versatile disc (DVD), a floppy disk, a magnetic tape, and/or another type of non-transitory computer-readable tangible storage device that can store a computer program and digital information.

Each set of internal components 800A,B also includes a RAY drive or interface 832 to read from and write to one or more portable computer-readable tangible storage devices 936 such as a CD-ROM, DVD, memory stick, magnetic tape, magnetic disk, optical disk or semiconductor storage device. A software program, such as the software program 108 (FIG. 2) and the Dynamic Resource Allocation Program 216 (FIG. 2) can be stored on one or more of the respective portable computer-readable tangible storage devices 936, read via the respective RAY drive or interface 832 and loaded into the respective computer-readable tangible storage device 830.

Each set of internal components 800A,B also includes network adapters or interfaces 836 such as a TCP/IP adapter cards; wireless Wi-Fi interface cards; or 3G, 4G, or 5G wireless interface cards or other wired or wireless communication links. The software program 108 (FIG. 2) and the Dynamic Resource Allocation Program 216 (FIG. 2) on the cloud server computer 214 (FIG. 2) can be downloaded to the client computer 202 (FIG. 2) and cloud server computer 214 from an external computer via a network (for example, the Internet, a local area network or other, wide area network) and respective network adapters or interfaces 836. From the network adapters or interfaces 836, the software program 108 and the Dynamic Resource Allocation Program 216 on the cloud server computer 214 are loaded into the respective computer-readable tangible storage device 830. The network may comprise copper wires, optical fibers, wireless transmission, routers, firewalls, switches, gateway computers and/or edge servers.

Each of the sets of external components 900A,B can include a computer display monitor 920, a keyboard 930, and a computer mouse 934. External components 900A,B can also include touch screens, virtual keyboards, touch pads, pointing devices, and other human interface devices. Each of the sets of internal components 800A,B also includes device drivers 840 to interface to computer display monitor 920, keyboard 930 and computer mouse 934. The device drivers 840, RAY drive or interface 832 and network adapter or interface 836 comprise hardware and software (stored in computer-readable tangible storage device 830 and/or ROM 824).

Some embodiments may relate to a system, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of resource allocation in a cloud computing environment, executable by a processor, the method comprising:
receiving a request for resource allocation from a user in a cloud computing environment;
determining a profile for the user based on one or more metrics;
assigning a workload allocation to the user based on the determined profile matching one or more clusters of other users;
monitoring a usage value of the assigned workload allocation to the user; and
upgrading the user immediately to a higher workload allocation based on the usage value exceeding a threshold value.

2. The method of claim 1, further comprising downgrading the user gradually based on determining that the user is underutilizing the allocated resources.

3. The method of claim 2, wherein the determination that the user is underutilizing the allocated resources corresponds to a determination that the user is idle or inactive for a predetermined amount of time.

4. The method of claim 1, wherein the profile for the user is determined based on calculating a nearest neighbor distance between the user and a plurality of other users in the one or more clusters.

5. The method of claim 1, further comprising assigning a new user to one of the one or more clusters based on identifying a role associated with the new user matches a largest number of users within the cluster.

6. The method of claim 1, wherein the metrics comprise a CPU usage amount, a memory usage amount, past usage for a given time period, a user role, a time and a day of the week, and types of API requests made by the user.

7. The method of claim 1, wherein the profile for the user is determined based on the metrics having predefined weight values.

8. A computer system for resource allocation in a cloud computing environment, the computer system comprising:
one or more computer-readable non-transitory storage media configured to store computer program code; and
one or more computer processors configured to access said computer program code and operate as instructed by said computer program code, said computer program code including:
receiving code configured to cause the one or more computer processors to receive a request for resource allocation from a user in a cloud computing environment;
determining code configured to cause the one or more computer processors to determine a profile for the user based on one or more metrics;
assigning code configured to cause the one or more computer processors to assign a workload allocation to the user based on the determined profile matching one or more clusters of other users;
monitoring code configured to cause the one or more computer processors to monitor a usage value of the assigned workload allocation to the user; and
upgrading code configured to cause the one or more computer processors to upgrade the user to a higher workload allocation immediately based on the usage value exceeding a threshold value.

9. The computer system of claim 8, further comprising downgrading code configured to cause the one or more computer processors to downgrade the user gradually based on determining that the user is underutilizing the allocated resources.

10. The computer system of claim 9, wherein the determination that the user is underutilizing the allocated resources corresponds to a determination that the user is idle or inactive for a predetermined amount of time.

11. The computer system of claim 8, wherein the profile for the user is determined based on calculating a nearest neighbor distance between the user and a plurality of other users in the one or more clusters.

12. The computer system of claim 8, further comprising assigning code configured to cause the one or more computer processors to assign a new user to one of the one or more clusters based on identifying a role associated with the new user matches a largest number of users within the cluster.

13. The computer system of claim 8, wherein the metrics comprise a CPU usage amount, a memory usage amount, past usage for a given time period, a user role, a time and a day of the week, and types of API requests made by the user.

14. The computer system of claim 8, wherein the profile for the user is determined based on the metrics having predefined weight values.

15. A non-transitory computer readable medium having stored thereon a computer program for resource allocation in a computing environment, the computer program configured to cause one or more computer processors to:
receive a request for resource allocation from a user in a cloud computing environment;
determine a profile for the user based on one or more metrics;
assign a workload allocation to the user based on the determined profile matching one or more clusters of other users;
monitor a usage value of the assigned workload allocation to the user; and
upgrade the user to a higher workload allocation immediately based on the usage value exceeding a threshold value.

16. The computer readable medium of claim 15, wherein the computer program is further configured to cause the one or more computer processors to downgrade the user gradually based on determining that the user is underutilizing the allocated resources.

17. The computer readable medium of claim 16, wherein the determination that the user is underutilizing the allocated resources corresponds to a determination that the user is idle or inactive for a predetermined amount of time.

18. The computer readable medium of claim 15, wherein the profile for the user is determined based on calculating a nearest neighbor distance between the user and a plurality of other users in the one or more clusters.

19. The computer readable medium of claim 15, wherein the computer program is further configured to cause the one or more computer processors to assign a new user to one of the one or more clusters based on identifying a role associated with the new user matches a largest number of users within the cluster.

20. The computer readable medium of claim 15, wherein the metrics comprise a CPU usage amount, a memory usage amount, past usage for a given time period, a user role, a time and a day of the week, and types of API requests made by the user.
